(19) United States
(12) Patent Application Publication
(10) Pub. No.: US 2016/0338009 A1
(43) Pub. Date: Nov. 17, 2016

(54) REDIRECTION FAILURE HANDLING IN A WIRELESS NETWORK

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/709,440

(22) Filed: May 11, 2015

(51) Int. Cl. H04W 68/12; H04W 68/00

(52) U.S. Cl. CPC H04W 68/12; H04W 68/005

(57) ABSTRACT

A user equipment (UE) reduces redirection failure resulting from failed paging responses and/or location area updates when a user equipment is redirected from a first radio access technology (RAT) to a second RAT in accordance with a mobile terminated (MT) call. The UE is redirected from a first RAT to a second RAT in response to receiving a page for a call. The UE searches for neighbor cells of a first cell when a first paging response failed for the first cell in the second RAT. The UE also attempts to acquire a neighbor cell. The UE sends a second paging response, with a redirection indicator, to either the first cell or the neighbor cell based on a signal quality of the first cell and a signal quality of the neighbor cell when a failure of the first paging response to the first cell occurred within a predetermined time period.

### BACKGROUND

1. Field

Aspects of the present disclosure relate generally to wireless communication systems, and more particularly, to a redirection procedure for handling failed paging responses and/or location area updates when a user equipment is redirected from a first radio access technology (RAT) to a second RAT in accordance with a mobile terminated (MT) call.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method of wireless communication includes redirecting a user equipment (UE) from a first radio access technology to a second radio access technology in response to receiving a page for a call. The method also includes searching for neighbor cells of a first cell when a first paging response failed for the first cell in the second radio access technology. The method also includes attempting to acquire one of the neighbor cells. The method further includes sending a second paging response, with a redirection indicator. The second paging response may be sent to either the first cell or the neighbor cell based on a signal quality of the first cell and a signal quality of the neighbor cell when a failure of the first paging response to the first cell occurred within a predetermined time period.

According to another aspect of the present disclosure, an apparatus for wireless communication includes means for redirecting a user equipment (UE) from a first radio access technology to a second radio access technology in response to receiving a page for a call. The apparatus may also include means for searching for neighbor cells of a first cell when a first paging response failed for the first cell in the second radio access technology. The apparatus may also include means for attempting to acquire one of the neighbor cells. The apparatus further includes means for sending a second paging response, with a redirection indicator. The second paging response may be sent to either the first cell or the neighbor cell based on a signal quality of the first cell and a signal quality of the neighbor cell when a failure of the first paging response to the first cell occurred within a predetermined time period.

Another aspect discloses an apparatus for wireless communication and includes a memory and at least one processor coupled to the memory. The processor(s) is configured to redirect a user equipment (UE) from a first radio access technology to a second radio access technology in response to receiving a page for a call. The processor(s) is also configured to search for neighbor cells of a first cell when a first paging response failed for the first cell in the second radio access technology. The processor(s) is also configured to attempt to acquire one of the neighbor cells. The processor(s) is further configured to send a second paging response, with a redirection indicator. The second paging response may be sent to either the first cell or the neighbor cell based on a signal quality of the first cell and a signal quality of the neighbor cell when a failure of the first paging response to the first cell occurred within a predetermined time period.

Yet another aspect discloses a computer program product for wireless communications in a wireless network having a non-transitory computer-readable medium. The computer readable medium has non-transitory program code recorded thereon which, when executed by the processor(s), causes the processor(s) to redirect a user equipment (UE) from a first radio access technology to a second radio access technology in response to receiving a page for a call. The program code also causes the processor(s) to search for neighbor cells of a first cell when a first paging response failed for the first cell in the second radio access technology. The program code also causes the processor(s) to attempt to acquire one of the neighbor cells. The program code further causes the processor(s) to send a second paging response, with a redirection indicator. The second paging response may be sent to either the first cell or the neighbor cell based on a signal quality of the first cell and a signal quality of the neighbor cell when a failure of the first paging response to the first cell occurred within a predetermined time period.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a user equipment (UE) in a telecommunications system.

FIG. 4 illustrates network coverage areas according to aspects of the present disclosure.

FIG. 5 is a flow diagram conceptually illustrating an example process for redirection failure handling in a wireless network according to one aspect of the present disclosure.

FIG. 6 is a block diagram illustrating a method for wireless communication according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

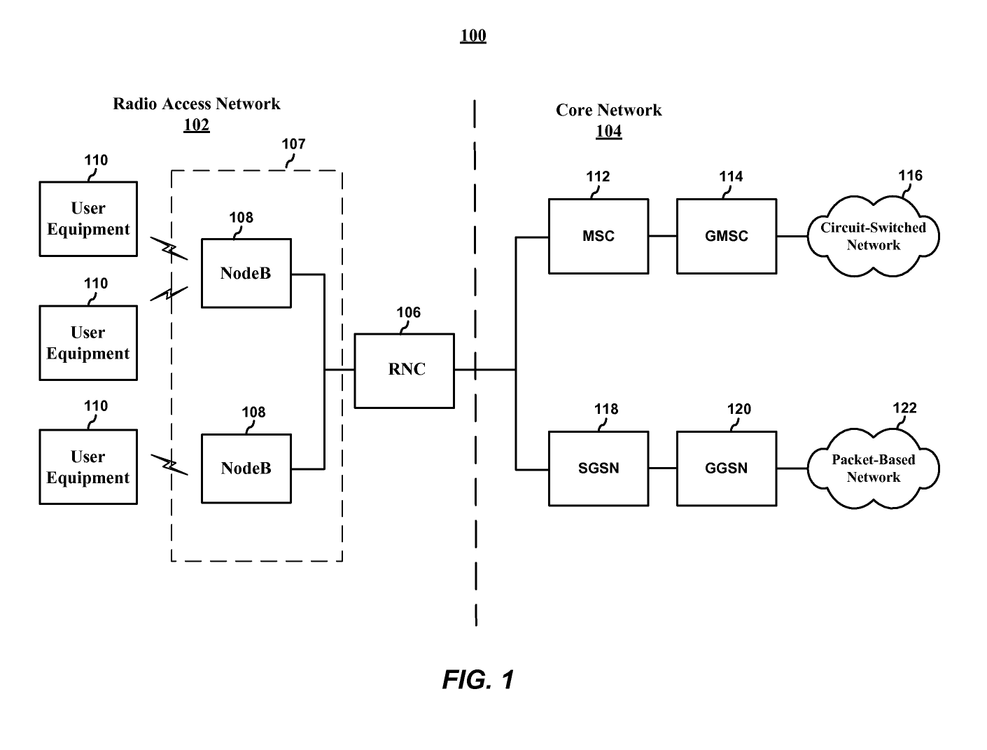

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

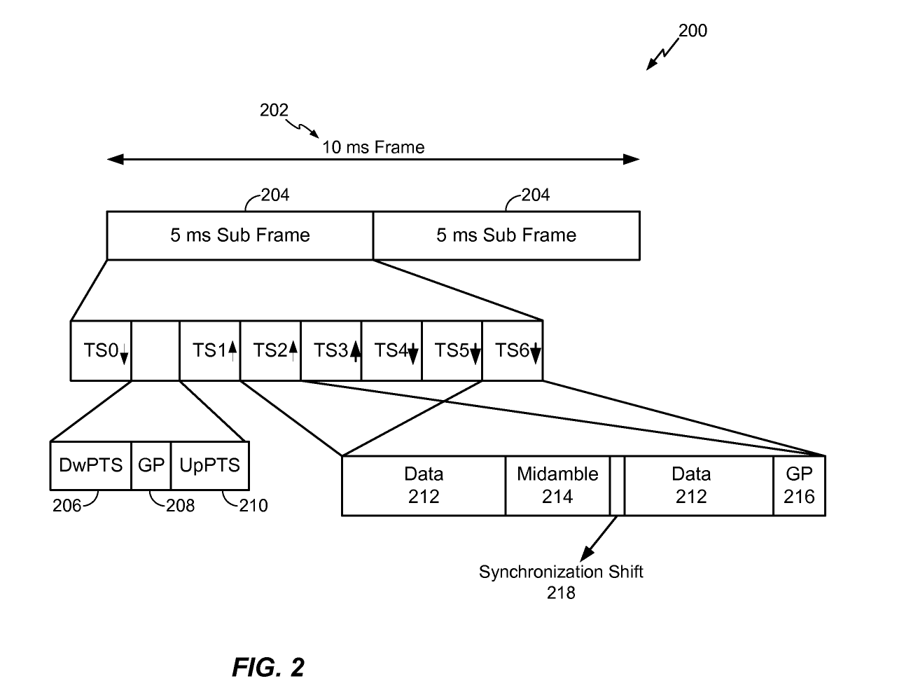

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

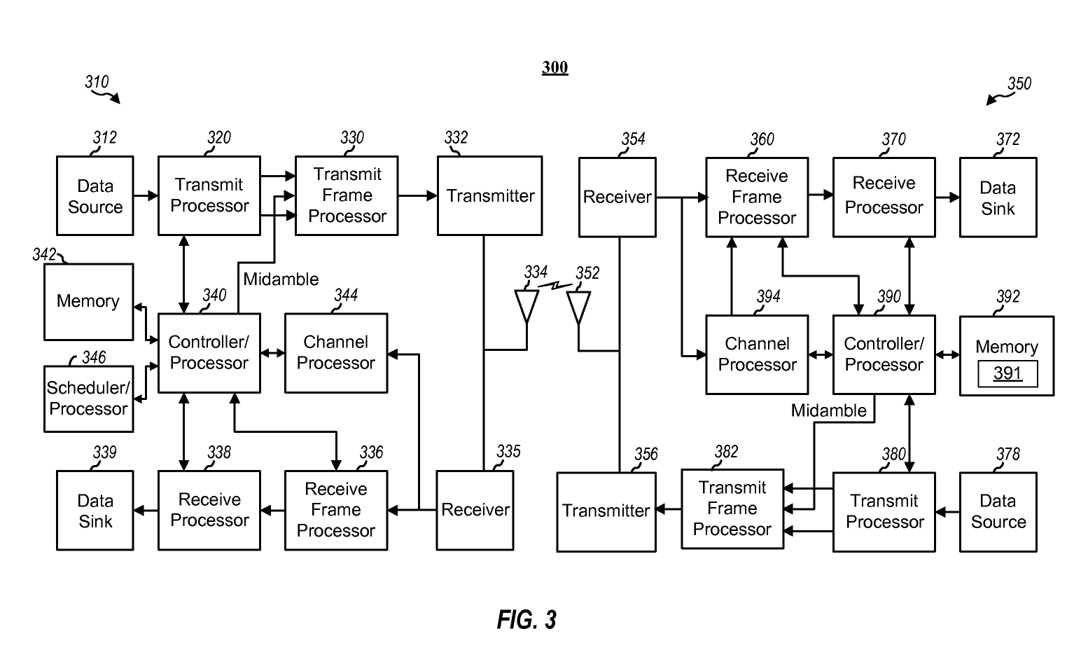

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a redirection failure handling module 391 which, when executed by the controller/processor 390, configures the UE 350 for the redirection implementation according to aspects of the present disclosure. A scheduler/processor 346 at the node B 310 may be used to allocate resources to the UEs and schedule downlink and/or uplink transmissions for the UEs.

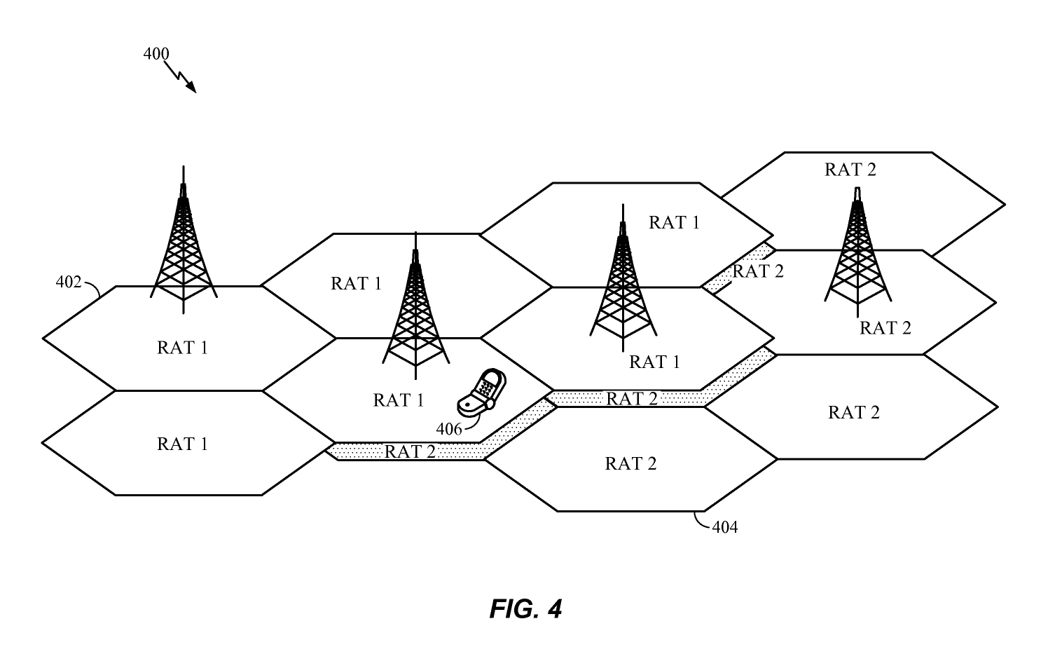

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or long term evolution (LTE) and also illustrates a newly deployed network utilizing a second type of radio access technology (RAT-2), such as long term evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may be redirected from a first RAT, such as a RAT-2 cell 404, to another RAT, such as a RAT-1 cell 402.

In some instances, when the UE is in a connected mode or idle mode with a serving RAT, the UE may be redirected to a target RAT to initiate or receive a voice call. Redirection from one RAT to another RAT is commonly used to perform operations such as load balancing or circuit-switched fallback (CSFB) from one RAT to another RAT. For example, one of the RATs may be long term evolution (LTE) while the other RAT may be universal mobile telecommunications system—frequency division duplexing (UMTS FDD), universal mobile telecommunications system—time division duplexing (UMTS TDD), or global system for mobile communications (GSM). In some aspects, the redirection may be from a frequency or cell of one RAT to a frequency or cell of the same RAT.

Circuit-switched fallback is a feature that enables multimode user equipments (UEs) that are capable of communicating on a first RAT (e.g., LTE) in addition to communicating on a second RAT (e.g., second/third generation (2G/3G) RAT) to obtain circuit-switched voice services while being camped on the first RAT. For example, the circuit-switched fallback capable UE may initiate a mobile-originated (MO) circuit-switched voice call while on LTE. Because of the mobile-originated circuit-switched voice call, the UE is redirected to a circuit-switched capable RAT. For example, the UE is redirected to a radio access network (RAN), such as a 3G/2G network, for the circuit-switched voice call setup. In some instances, the circuit-switched fallback capable UE may be paged for a mobile-terminated (MT) voice call while on LTE, which results in the UE being moved to 3G or 2G for the circuit-switched voice call setup.

A user equipment (UE) may receive a circuit-switched (CS) page from a first base station of a first radio access technology (RAT) or initiate a circuit-switched call to the first base station. For example, a circuit-switched fallback capable UE may be paged for a mobile-terminated (MT) voice call while on the first RAT (e.g., long term evolution (LTE)) or may initiate a mobile-originated (MO) circuit-switched voice call while the user equipment is in LTE connected or idle mode. In response to the page, the UE is redirected to a second RAT (e.g., third generation (3G)/second generation (2G)) to set up the circuit-switched voice call. For example, to set up the circuit-switched voice call on the second RAT, the UE may receive a connection release message from a base station of the first RAT. The connection release message may include redirection information that indicates the RAT (e.g., target base station of a second RAT), frequency and/or cell to which the user equipment is to be redirected for the circuit-switched fallback call. The redirection information may also include system information. For example, the redirection information may include base station identifiers with associated system information, a list of frequencies, cell IDs and broadcast system information, such as MIBs and/or SIBs (master information blocks and/or system information blocks). In some instances, however, the connection release message may not include the redirection information.

After the UE is redirected to the circuit-switched RAT, such as 2G or 3G, the UE selects the strongest frequency from the list of frequencies in the redirection information carried in a non-circuit-switched RAT (e.g., LTE) radio resource control (RRC) connection release message. The selection of the strongest frequency may include selecting the frequency with the strongest signal quality based on measurement of the signal quality of the frequencies. During some circuit-switched fallback deployments, however, redirection is performed blindly without the UE performing measurement and reporting the measurement on the circuit-switched RAT. The blind redirection is intended to reduce latency of circuit-switched fallback by eliminating the time spent for measurement and reporting on the circuit-switched RAT.

In some instances, the list of frequencies in the redirection information may be statically configured for a base station of a RAT (e.g., LTE NodeB) and may not be good for all locations in the base station coverage. In addition, the frequencies in the list for the circuit-switched RAT in a redirection command are limited in order to reduce the search and camping procedure of the UE.

It was observed that after the UE camped on a best cell in the frequency list in the redirection information, a paging response procedure and/or location area update procedure may be implemented. The paging response procedure and/or location area update procedure may occur when the UE is redirected from a first radio access technology to a second RAT.

The paging response procedure and/or location area update procedure may include one or more procedures that are subject to different types of failures. For example, the failures may be due to circuit-switched RAT broadcast control channel (BCCH) decoding failure on the selected cell, random access channel (RACH) failure on the selected cell, radio link failure during paging response or location update procedure, improper frequency list in the redirection information, circuit-switched RAT base station controller/radio network controller (BSC/RNC) load failure, mobile switching center (MSC) load, etc.

The one or more procedures may include sending a first paging response to the circuit-switched RAT in response to the mobile terminated call and/or sending a location area update in response to a change of location of a cell of the circuit-switched RAT. The paging response and/or location area update, however, may be sent unsuccessfully or fail. The failure may be due to one or more of the different types of failures noted above. When the UE sends a first paging response to the circuit-switched RAT and the first paging response is unsuccessful, or a first location area update is unsuccessful, the call setup procedure is stopped. Stopping the call setup procedure results in dropped calls that adversely affect user experience.

### Redirection Failure Handling in a Wireless Network

Aspects of the disclosure are directed to a redirection (e.g., circuit-switched fallback (CSFB)) procedure for handling a failed paging response and/or location area update by a user equipment (UE). The location area update may be implemented with or without a redirection indicator (e.g., a circuit-switched fallback mobile terminated indication flag). The redirection indicator informs the second RAT that a call, such as a mobile terminated (MT) call, is being redirected from the first RAT. The UE may be redirected to or fall back to the second RAT in response to receiving a page for the call on the first RAT.

When the first paging response procedure failure and/or location area update procedure failure occurs, the UE determines whether a time, from receiving the page for the mobile terminated call until the failure(s), is shorter than a predetermined threshold. The UE may search for and/or acquire a neighbor layer of the first layer of the second RAT when the first failure occurs. The term “layer” is intended to cover frequency and/or cell and may be used interchangeably with “cell/frequency.” The RAT of the neighbor layers may be the same as or different from the first RAT and/or the second RAT. For example, the UE searches for and/or attempts to acquire a better cell/frequency than the first cell/frequency to complete the call setup. In some aspects, the acquisition of a new cell means a cell location change and a corresponding location area update procedure to inform the network of the different cell location.

When the first paging response procedure failure and/or location area update procedure failure of the second RAT occurs within a predetermined time period (i.e., when the time is shorter than the threshold), the UE sends a second or more paging responses. For example, when the UE is redirected to the first cell/frequency of the second RAT, the UE unsuccessfully sends a first paging response and/or location area update with the redirection indicator. The UE then sends the second or more paging responses and/or a second or more location area updates with the redirection indicator to the first cell/frequency of the second RAT. Alternatively, the UE may send the second or more paging responses and/or a second or more location area updates with the redirection indicator to the neighbor cell/frequency of the second RAT.

The UE sends the second (or more) paging response to the neighbor cell/frequency or the first cell/frequency, depending on a signal quality of the neighbor cell/frequency and/or the first cell/frequency. That is, the UE selects and sends the paging response to the stronger of the two cells. It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc. Signal quality is intended to cover the term signal strength, as well.

In some aspects of the disclosure, the UE sends a location area update (LAU) with the redirection indicator, along with the second page response to the cell of the second RAT when the location of the cell (or base station) changed and the time is shorter than the threshold. For example, the UE performs a location update procedure with a mobile terminated circuit-switched fallback indication when a location area code of the cell of the second RAT is different or changed. The location area update procedure may be performed with the stronger cell. The second or more page responses or location area updates may be sent after the UE camps on a same or different cell/frequency.

The location of a cell and corresponding location area code may change while the UE is redirected from the first RAT to the second RAT or may be subject to change after a power scan. The location of the cell may also change during system information collection (e.g., system information block (SIB) collection.)

The location area update and/or the redirection indicator may cause the network to hold the call. For example, the redirection indicator informs the network of the pending call, which causes the network to hold the call. Without the redirection indicator, the network may release the call.

The location area update (LAU) with the redirection indication, along with the second or more page responses are sent when a location of the cell of the second RAT changed while the user equipment is redirected from the first RAT to the second RAT. Sending the redirection indicator provides some benefits to the redirection procedure. For example, sending the redirection indicator to the first cell/frequency or neighbor cell/frequency causes the call setup process to be expedited or prioritized.

In some aspects of the disclosure, when the time is not shorter than the threshold, the UE aborts the first page response. When the location area code(s) of the cell(s) of the second RAT changes, the UE also aborts the location area update procedure with the redirection indicator. In this aspect, the UE performs a normal location update procedure without the redirection indicator, which may cause the network to release the call. In this aspect, the page for the mobile terminated call may be directly sent to the UE via the second RAT after completing any appropriate location area update procedure.

The paging response procedure failure and/or location area update procedure failure may be attributed to different types of failure. For example, the failure(s) may be due to a redirection RAT (e.g., circuit-switched) broadcast control channel (BCCH) decoding failure on the selected cell, random access channel (RACH) failure on the selected cell, connection setup failure, radio link failure during page response or location update, improper frequency list in the redirection information, redirection RAT base station controller/radio network controller (BSC/RNC) load failure, mobile switching center (MSC) load, layer two synchronization failure caused by sending a same message for a sequence number multiple times without receiving an acknowledgment from the network, and other redirection procedure failures.

In some aspects of the disclosure, the UE sends a location area update (LAU) without the redirection indicator when the first paging response procedure failure and/or location area update procedure failure occurred after the predetermined time period. In this aspect, the location area update is sent by the UE to the selected cell/frequency of the second RAT. The location area update is sent even when the location of the selected cell/frequency of the second RAT is unchanged. Normally, the UE stops sending the location area update when the location of the cell is unchanged. In this case, sending the location area update when the location of the cell is unchanged improves throughput of the call setup because the network continues to receive information from the UE, helping to maintain the connection.

The predetermined time period can be adjusted based on the type of failure and when it occurs. For example, the predetermined time period is shortened when the failure occurs earlier in the paging response procedure and/or location area update procedure. An example of a failure type that occurs earlier is a random access channel (RACH) failure where the UE may unsuccessfully send a preamble to the second RAT. The predetermined time period is increased when the failure occurs later in the paging response procedure and/or location area update procedure. An example of a failure type that occurs later is layer 2 synchronization failure caused by sending a same message for a sequence number multiple times without receiving an acknowledgment from the network, and other redirection procedure failures.

In yet another aspect of the disclosure, the predetermined time is adjusted based on the signal quality of the first cell/frequency. The predetermined time can also be adjusted based on a signal quality of the neighbor cell/frequency, as well as a difference between the signal quality of the first cell/frequency and the neighbor cell/frequency. For example, if the first cell/frequency is much stronger during a second search, then the adjustment of the predetermined time is based on a difference between the first and second signal quality measurements of the first cell/frequency.

When the second RAT (e.g., circuit-switched RAT) base station controller or radio network controller receives a second or more page responses or location area updates with a redirection indicator, the base station controller forwards the page response(s) or the indication to the mobile switching center (MSC) (based on network resource identifier (NRI)). The mobile switching center then initiates the paging response procedure. The MSC next proceeds with the call establishment procedure if the time related to the page response procedure has not expired.

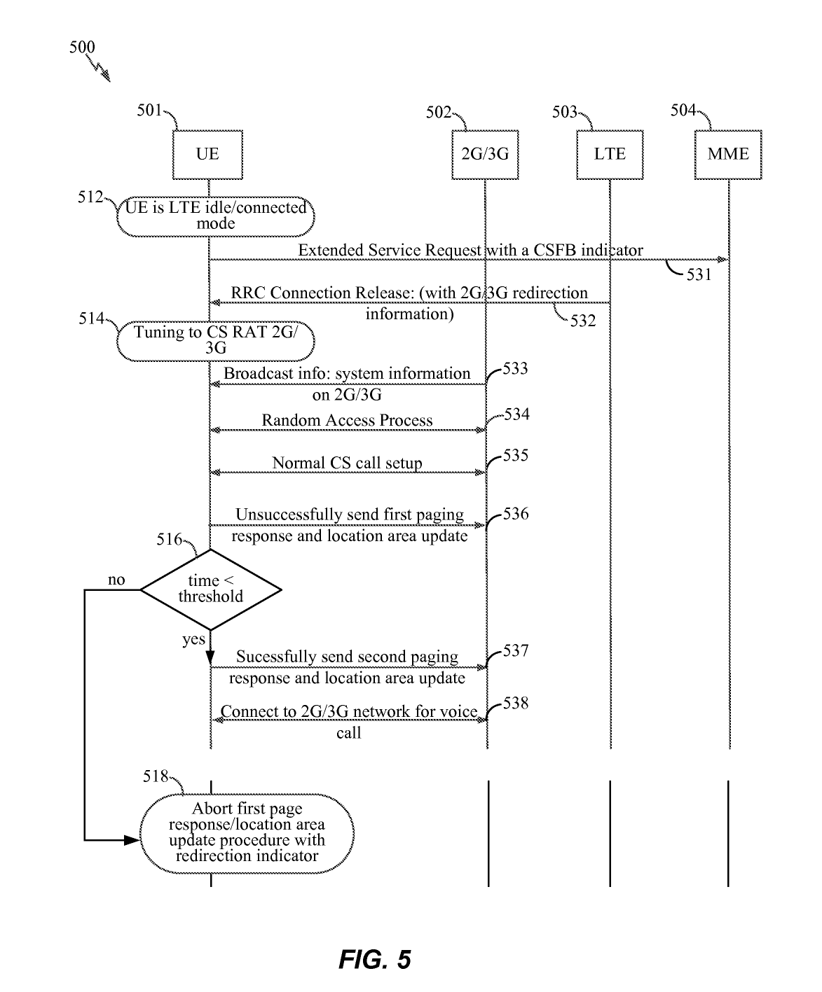

FIG. 5 shows a flow diagram 500 conceptually illustrating an example process for redirection failure handling in a wireless network according to one aspect of the present disclosure. A user equipment (UE) 501 at time 512 may be camped on a dedicated LTE network. Then, the UE 501 may originate or receive a voice call and a redirection procedure may be invoked to service the voice call.

The redirection procedure is implemented to redirect the UE from one radio access technology (RAT) to another RAT for a particular service and it is commonly used for services such as load balancing, circuit-switched fallback (CSFB) from LTE to other RATs, and others. Example of RATs that the UE is redirected to may include universal mobile telecommunications system (UMTS) frequency division duplex (FDD), UMTS TDD (time division duplex), and global System for mobile communications (GSM).

In this example, the UE 501 is a multimode, circuit-switched fallback-capable UE supporting 2G/3G and LTE capabilities and may use the circuit-switched fallback feature for circuit-switched (CS) voice services while being camped on a LTE network 503. The UE 501 may be paged for a mobile-terminated (MT) voice call while camped on the LTE network 503, resulting in the UE 501 moving to the 2G/3G network 502 for CS voice call setup.

At time 531, the UE 501 sends an extended service request (ESR) to a mobility management entity (MME) 504 to initiate a redirection for a circuit-switched fallback service. A redirection indicator (e.g., circuit-switched fallback indicator) is included in the extended service request message. At time 532, the LTE network 503 sends a radio resource connection (RRC) connection release message with 2G/3G redirection information to initiate a redirection to the circuit-switched fallback-capable 2G/3G network 502. At time 514, as part of redirection to the 2G/3G network 502, the UE 501 tunes to a 2G/3G RAT to acquire information about the 2G/3G network 502. At time 533, the 2G/3G network 502 broadcasts its system information on a 2G/3G RAT broadcast channel.

At time 534, after receiving the system information, the UE 501 and the 2G/3G network 502 may enter a random access process to establish a connection between the UE 501 and the 2G/3G network 502. At time 535, the UE 501 and the 2G/3G network 502 go through a normal call setup procedure to enable voice call service. For example, at time 536 the UE 501 unsuccessfully sends a paging response and/or a location area update with redirection indicator to the 2G/3G network 502. As noted, the location area update may be sent with or without the redirection indicator. The location area update procedure may be implemented when a location of a cell of the 2G/3G network 502, for the call changes. The change in the cell location may be identified in the received system information. At time 516, the UE 501 determines whether a time, from receiving the page for the mobile terminated call until the failure (i.e., the unsuccessful transmission of the first paging response and/or the location area update), is below a predetermined threshold.

When the time is below the predetermined threshold, the UE 501 sends a second paging response and/or location area update with the redirection indicator, at time 537. In this case, the second paging response and/or location area update is successfully sent. At time 538, the UE 501 connects to the strongest cell of the 2G/3G network 502 for the voice call. When the time is not below the threshold, the UE 501 aborts the first page response, at time 518. As noted, when the location area code(s) of the cell(s) of the second RAT changes, the UE 501 also aborts the location area update procedure with the redirection indicator. In this aspect, the UE performs a normal location update procedure without the redirection indicator, which may cause the network to release the call.

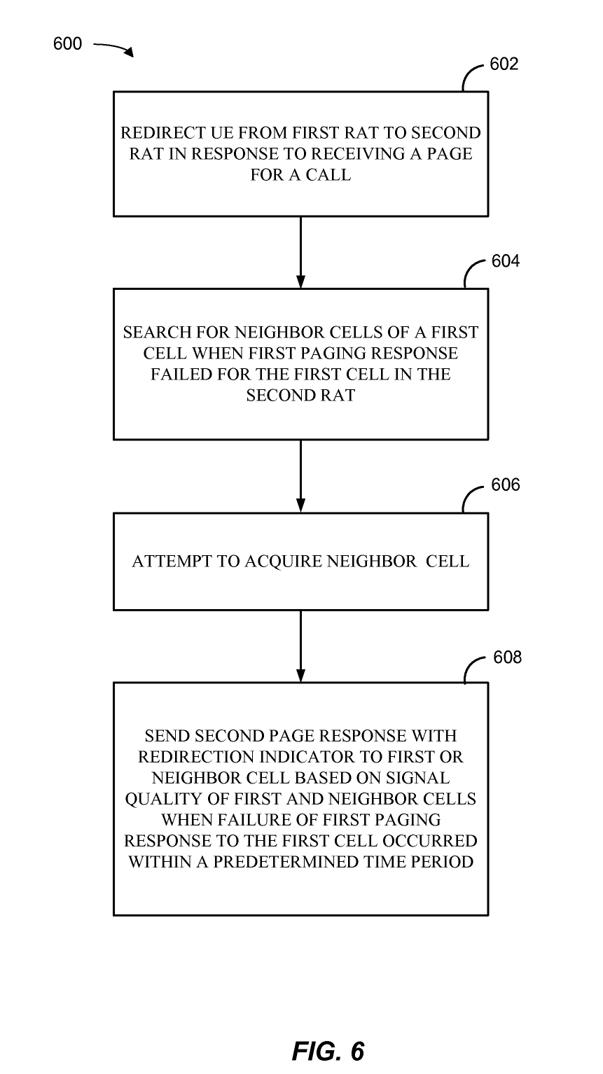

FIG. 6 shows a wireless communication method 600 according to one aspect of the disclosure. A user equipment (UE) is redirected from a first radio access technology to a second radio access technology in response to receiving a page for a call, as shown in block 602. The UE searches for neighbor cells of a first cell when a first paging response failed for the first cell in the second radio access technology, as shown in block 604. In addition, the UE attempts to acquire the neighbor cell, as shown in block 606.

Finally, the UE sends a second paging response, with a redirection indicator, to either the first cell or the neighbor cell based on a signal quality of the first cell and the neighbor cell, as shown in block 608. The UE sends the second paging response when a failure of the first paging response to the first cell/frequency occurred within a predetermined time period.

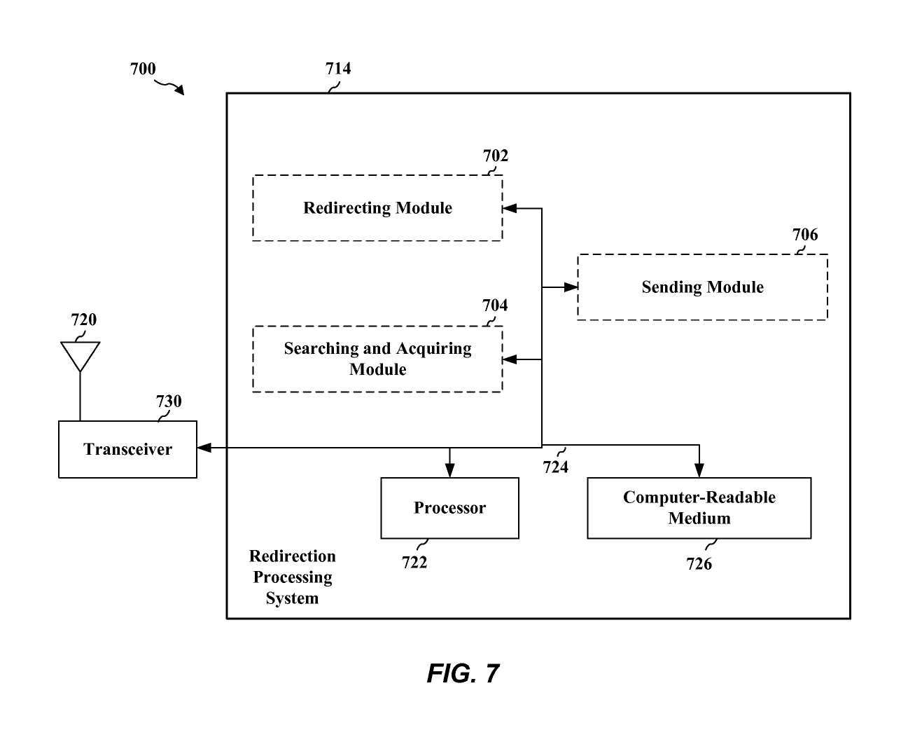

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatuses over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes an redirecting module 702 for redirecting a user equipment (UE) from a first radio access technology to a second radio access technology in response to receiving a page for a call. The processing system 714 also includes a searching and acquiring module 704 for searching for neighbor cells of a first cell when a first paging response failed for the first cell in the second radio access technology. The searching and acquiring module 704 also attempts to acquire the neighbor cell. The processing system 714 also includes a sending module 706 for sending a second paging response, with a redirection indicator, to either the first cell or the neighbor cell. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for redirecting. In one aspect, the redirecting means may be the antennas 352/720, the receiver 354, the transceiver 730, the channel processor 394, the receive frame processor 360, the receive processor 370, the transmitter 356, the transmit frame processor 382, the transmit processor 380, the controller/processor 390, the memory 392, the redirection failure handling module 391, the redirecting module 702, and/or the processing system 714 configured to perform the aforementioned means. In another aspect, the aforementioned means may be a module or any apparatus configured to perform the functions recited by the aforementioned means.

The UE is also configured to include means for searching and acquiring. In one aspect, the searching and acquiring means may be the antennas 352/720, the receiver 354, the transceiver 730, the channel processor 394, the receive frame processor 360, the receive processor 370, the controller/processor 390, the memory 392, the redirection failure handling module 391, the searching and acquiring module 704, and/or the processing system 714 configured to perform the aforementioned means. In one configuration, the means functions correspond to the aforementioned structures. In another aspect, the aforementioned means may be a module or any apparatus configured to perform the functions recited by the aforementioned means.

The UE is also configured to include means for sending. In one aspect, the sending means may be the antennas 352/720, the transceiver 730, the transmitter 356, the transmit frame processor 382, the transmit processor 380, the controller/processor 390, the memory 392, the redirection failure handling module 391, the sending module 706 and/or the processing system 714 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
redirecting a user equipment (UE) from a first radio access technology to a first cell of a second radio access technology in response to receiving a page for a call;
searching for neighbor cells of the first cell when a first paging response failed for the first cell in the second radio access technology;
attempting to acquire one of the neighbor cells; and
sending a second paging response, with a redirection indicator, to either the first cell or a neighbor cell of the neighbor cells based at least in part on a signal quality of the first cell and a signal quality of the neighbor cell when a failure of the first paging response to the first cell occurred within a predetermined time period.

2. The method of claim 1, further comprising sending a location area update (LAU) with the redirection indicator, along with the second paging response, when the user equipment identifies a cell location change while changing from the first radio access technology to the second radio access technology.

3. The method of claim 1, in which a cause of the first paging response failure comprises at least one of random access failure, connection setup failure, or layer two synchronization failure.

4. The method of claim 1, further comprising sending a location area update (LAU) without the redirection indicator when the failure occurred after the predetermined time period and a cell location identified by the user equipment is unchanged.

5. The method of claim 1, further comprising adjusting the predetermined time period based at least in part on the signal quality of the first cell and a cause of the paging response failure, signal qualities of the neighbor cells, and a difference between the signal quality of the first cell and/or the signal qualities of the neighbor cells.

6. An apparatus for wireless communication, comprising:
means for redirecting a user equipment (UE) from a first radio access technology to a first cell of a second radio access technology in response to receiving a page for a call;
means for searching for neighbor cells of the first cell when a first paging response failed for the first cell in the second radio access technology;
means for attempting to acquire one of the neighbor cells; and
means for sending a second paging response, with a redirection indicator, to either the first cell or a neighbor cell of the neighbor cells based at least in part on a signal quality of the first cell and a signal quality of the neighbor cell when a failure of the first paging response to the first cell occurred within a predetermined time period.

7. The apparatus of claim 6, further comprising means for sending a location area update (LAU) with the redirection indicator, along with the second paging response, when the user equipment identifies a cell location change while changing from the first radio access technology to the second radio access technology.

8. The apparatus of claim 6, in which a cause of the first paging response failure comprises at least one of random access failure, connection setup failure, or layer two synchronization failure.

9. The apparatus of claim 6, further comprising means for sending a location area update (LAU) without the redirection indicator when the failure occurred after the predetermined time period and a cell location identified by the user equipment is unchanged.

10. The apparatus of claim 6, further comprising means for adjusting the predetermined time period based at least in part on the signal quality of the first cell and a cause of the paging response failure, signal qualities of the neighbor cells, and a difference between the signal quality of the first cell and/or the signal qualities of the neighbor cells.

11. An apparatus for wireless communication, comprising:
a memory; and
at least one processor coupled to the memory and configured:
to redirect a user equipment (UE) from a first radio access technology to a first cell of a second radio access technology in response to receiving a page for a call;
to search for neighbor cells of the first cell when a first paging response failed for the first cell in the second radio access technology;
to attempt to acquire one of the neighbor cells; and
to send a second paging response, with a redirection indicator, to either the first cell or a neighbor cell of the neighbor cells based at least in part on a signal quality of the first cell and a signal quality of the neighbor cell when a failure of the first paging response to the first cell occurred within a predetermined time period.

12. The apparatus of claim 11, in which the at least one processor is further configured to send a location area update (LAU) with the redirection indicator, along with the second paging response, when the user equipment identifies a cell location change while changing from the first radio access technology to the second radio access technology.

13. The apparatus of claim 11, in which a cause of the first paging response failure comprises at least one of random access failure, connection setup failure, or layer two synchronization failure.

14. The apparatus of claim 11, in which the at least one processor is further configured to send a location area update (LAU) without the redirection indicator when the failure occurred after the predetermined time period and a cell location identified by the user equipment is unchanged.

15. The apparatus of claim 11, in which the at least one processor is further configured to adjust the predetermined time period based at least in part on the signal quality of the first cell and a cause of the paging response failure, signal qualities of the neighbor cells, and a difference between the signal quality of the first cell and/or the signal qualities of the neighbor cells.

16. A computer program product for wireless communication, comprising:
a non-transitory computer-readable medium having program code recorded thereon, the program code comprising:
program code to redirect a user equipment (UE) from a first radio access technology to a first cell of a second radio access technology in response to receiving a page for a call;
program code to search for neighbor cells of the first cell when a first paging response failed for the first cell in the second radio access technology;
program code to attempt to acquire one of the neighbor cells; and
program code to send a second paging response, with a redirection indicator, to either the first cell or a neighbor cell of the neighbor cells based at least in part on a signal quality of the first cell and a signal quality of the neighbor cell when a failure of the first paging response to the first cell occurred within a predetermined time period.

17. The computer program product of claim 16, further comprising program code to send a location area update (LAU) with the redirection indicator, along with the second paging response, when the user equipment identifies a cell location change while changing from the first radio access technology to the second radio access technology.

18. The computer program product of claim 16, in which a cause of the first paging response failure comprises at least one of random access failure, connection setup failure, or layer two synchronization failure.

19. The computer program product of claim 16, further comprising program code to send a location area update (LAU) without the redirection indicator when the failure occurred after the predetermined time period and a cell location identified by the user equipment is unchanged.

20. The computer program product of claim 16, further comprising program code to adjust the predetermined time period based at least in part on the signal quality of the first cell and a cause of the paging response failure, signal qualities of the neighbor cells, and a difference between the signal quality of the first cell and/or the signal qualities of the neighbor cells.
